(19) United States
(12) Patent Application Publication
(10) Pub. No.: US 2015/0343325 A1
(43) Pub. Date: Dec. 3, 2015

(54) APPARATUS FOR REMOVING DISSOLVED WATER FROM WATER-CONTAINING FLUID AND CHAMBER FOR THE APPARATUS

(71) Applicant: SAMYOUNG FIL-TECH CO., LTD., Geumcheon-gu Seoul (KR)

(72) Inventor: Kyung Hoe Koo, Seoul (KR)

(73) Assignee: SAMYOUNG FIL-TECH CO., LTD., Geumcheon-gu Seoul (JP)

(21) Appl. No.: 14/420,486

(22) PCT Filed: May 27, 2014
(86) PCT No.: PCT/KR2014/004744

§ 371 Date: Feb. 9, 2015

(30) Foreign Application Priority Data
Dec. 12, 2013 (KR) 10-2013-0154989

(51) Int. Cl. B01D 3/10; C10M 175/00; B01D 3/42

(52) U.S. Cl. CPC B01D 3/106; B01D 3/42; C10M 175/0025

(57) ABSTRACT

An apparatus for removing dissolved water from a water-containing fluid and a chamber for the same apparatus. The apparatus sprays a water-containing fluid which is a hydrophobic fluid, such as industrial oil in which water is dissolved, into a chamber that maintains a high vacuum pressure of 70 Torr (abs) or lower. The apparatus can effectively remove the dissolved water using a difference in saturated vapor pressure even in a state where a to-be-recycled hydrophobic fluid is heated to a moderate temperature, at which the hydrophobic fluid does not undergo a chemical change. Specifically, the chamber has a dual structure made up of an upper chamber and a lower chamber, thereby maximizing effects of fluid discharge and water removal.

### CROSS REFERENCE RELATED APPLICATION

This application claims foreign priority of Korean Patent Application No. 10-2013-0154989, filed on Dec. 12, 2013, which is incorporated by reference in its entirety into this application.

### TECHNICAL FIELD

The disclosure relates to an apparatus for removing dissolved water from a water-containing fluid and a chamber for the apparatus. More particularly, the disclosure relates to an apparatus for removing dissolved water from a water-containing fluid and a chamber for the same apparatus which removes the dissolved water in a manner of spraying the water-containing fluid (for example, a hydrophobic fluid such as an industrial oil in which water is dissolved) into the chamber, maintained as a high vacuum having a vacuum pressure of 70 Torr (abs) or lower, in order to effectively separate and remove the dissolved water using a difference in saturated vapor pressure; even when a to-be-recycled hydrophobic fluid is heated to a moderate temperature at which the hydrophobic fluid does not undergo a chemical change; wherein the chamber has a dual structure including an upper chamber and a lower chamber, thereby maximizing effects of fluid-discharging and water removal.

### BACKGROUND ART

Generally, various industrial oils (for example, mineral oil, synthetic oil, vegetable oil, animal oil, etc.) are used in industrial plants such as power generation stations and hydraulic systems.

Industrial oils are generally hydrophobic thus they have to be managed not to be exposed to moisture or water. However, moisture or water is inevitably and undesirably dissolved in oils in the course of usage in various industrial conditions over a long period of time, resulting in a water-containing fluid being produced.

The dissolved water in the water-containing fluid causes malfunctioning or deterioration of industrial equipment. For example, water dissolved in a lubricant leads to various mechanical problems such as corrosion of equipment, deterioration in the performance of the lubricant, destruction of oil films, abrasion and wear of mechanical parts, and oxidation of the lubricant. Therefore, it is necessary to remove the water contained in the water-containing fluid.

There is a known technology which can remove dissolved water from a water-containing fluid, as specified by Korean Patent No. 10-0407161 (registered as of Nov. 13, 2003). According to this technology, when a heated waste lubricant is sprayed into an evaporation chamber using a vacuum state formed in the evaporation chamber, water contained in the waste lubricant evaporates due to a correlation between saturation vapor pressure and temperature of water and lubricant, condenses while passing through a condenser, and collects in a condensate water tank. The dehydrated waste lubricant is introduced into a discharge chamber by a discharging means and stored in a waste lubricant tank by an oil pump.

According to the construction of the known technology, an upper position sensor and a lower position sensor are installed on the top and bottom of each of an evaporation chamber and a discharge chamber so that levels of water in the evaporation chamber and the discharge chamber can be monitored. In addition, when the amount of a waste lubricant sprayed into the evaporation chamber reaches a predetermined value, the waste lubricant is transported to the discharge chamber by the discharging means. In addition, when the amount of the waste lubricant introduced into the discharge chamber reaches or exceeds a predetermined value, a ventilation pipe connected to the discharge chamber is opened, purging the inside of the discharge chamber, which alleviates the vacuum degree of the discharge chamber and causes the dehydrated waste lubricant to be transported into the waste lubricant tank by the discharging means (i.e.: an oil pump).

The vacuum-purging process is performed before the waste lubricant introduced into the discharge chamber is discharged outside for the following reason: when the discharge chamber maintains a high vacuum state in which the vacuum pressure is 70 Torr (abs) or lower, an ordinary oil pump that is used as the discharging means cannot discharge oil outside the discharge chamber, and the oil is likely to back-flow into the discharge chamber. That is, by changing the high vacuum state of the discharge chamber to a low vacuum state in which the pressure is almost the same as an atmospheric pressure, it is possible to create conditions in which a discharge pressure of an oil pump is adequate.

However, the above-described technology is disadvantageous in terms of operation efficiency of equipment because the internal pressure of the discharge chamber is alternated between a high vacuum pressure, at which the discharge chamber is in equilibrium with the evaporation chamber in terms of internal pressure, and an atmospheric pressure (or a lower vacuum pressure almost the same as the atmospheric pressure), at which the waste lubricant can be discharged.

On the other hand, according to the known technology, when the waste lubricant in the discharge chamber is discharged outside, lowering the level of the lubricant to a predetermined level: the ventilation pipe is closed and operation of the oil pump is stopped; then the vacuum chamber attains an equilibrium in vacuum degree with the evaporation chamber to which the discharge chamber is connected via a pressure adjustment pipe; the vacuum degrees of the evaporation chamber and the discharge chamber are returned to the initial vacuum degree by activation of a vacuum pump; and spraying of the waste lubricant through the nozzle of the evaporation chamber is continuously performed throughout this process.

During a period in which the vacuum degree of the discharge chamber is recovered to the initial vacuum degree (i.e.: the period in which the vacuum degrees of the discharge chamber and the evaporation chamber reach an equilibrium with each other), since the pressure of the evaporation chamber becomes a low vacuum pressure rather than the intended high vacuum pressure which is 70 Torr (abs) or lower, the temperature of a waste lubricant needs to be increased relative to the temperature which is set for the high vacuum pressure conditions, of no higher than 70 Torr (abs), before the waste lubricant is introduced into the evaporation chamber so that the evaporation conditions, under which water contained in the waste lubricant can evaporate, are maintained. For example, when the vacuum pressure is 760 Torr (low vacuum pressure condition), water evaporates at about 100° C. However, when the vacuum pressure is 70 Torr (abs) (high vacuum pressure conditions), water evaporates at about 44.40° C. That is, water evaporates at a higher temperature under low vacuum pressure conditions than that in a high vacuum pressure conditions.

However, organic chemicals such as industrial oils are likely to undergo a chemical change at a certain temperature. For example, a waste lubricant undergoes an abrupt chemical change at about 80° C. Therefore, in order to prevent the chemical change of the waste lubricant that is to be recycled, limitations should be imposed on heating conditions of the waste lubricant or operation conditions of equipment.

On the other hand, according to the known technology, as the water levels in the evaporation chamber and the discharge chamber are separately managed, control needs to be performed such that timing of the high water level (discharge timing) in the evaporation chamber does not overlap with timing of the high water level (discharge timing) in the discharge chamber.

The control of the discharge timings is a limiting factor in terms of operation efficiency of equipment. Erroneous or imprecise control results in malfunctioning of equipment or accidents.

For example, when the timing of the high water level in the discharge chamber and the timing of the high water level in the evaporation chamber overlap each other, a problematic situation in which the waste lubricant in the evaporation chamber cannot be transported to the discharge chamber occurs. This may result in malfunctioning of equipment or an occurrence of an environmental pollution incident in which the waste lubricant, rather than water, is leaked outside the discharge chamber.

On the other hand, according to the known technology, in order to prevent moisture that evaporated in the evaporation chamber from condensing due to a temperature difference between the inside and outside of the evaporation chamber, a heating device, such as a hot wire, is embedded in the cover of the evaporation chamber.

The heating device causes not only the inconvenience of the installation and management of an additional heat source, but also a problem of the inappropriate control of a heating temperature potentially subjecting the waste lubricant to a chemical change.

### DISCLOSURE

### Technical Problem

Accordingly, the disclosure has been made keeping in mind the above problems occurring in the related art, and an object of the disclosure is to provide an apparatus for removing dissolved water from a water-containing fluid and a chamber for the same apparatus that removes the dissolved water in a manner of spraying the water-containing fluid (for example, a hydrophobic fluid such as an industrial oil in which water is dissolved) into the chamber that maintains a high vacuum pressure of 70 Torr (abs) or lower in order to effectively separate and remove the dissolved water using a difference in saturated vapor pressure, even under conditions in which a to-be-recycled hydrophobic fluid is heated to a moderate temperature at which the hydrophobic fluid does not undergo a chemical change, wherein the chamber has a dual structure including an upper chamber and a lower chamber, thereby maximizing the effect of fluid discharging and water removal.

### Technical Solution

In order to accomplish the object of the disclosure, according to one aspect, there is provided an apparatus for removing dissolved water from a water-containing fluid, comprising: an upper chamber into which the water-containing fluid is sprayed through a spray nozzle under a vacuum pressure condition, in which the dissolved water contained in the water-containing fluid is evaporated, and from which the evaporated water and a dehydrated fluid, which is a remnant of the water-containing fluid after the dissolved water is evaporated, are discharged separately; a lower chamber, which is connected to the upper chamber via a first pipe and a first switching valve, into and in which the dehydrated fluid is introduced and stored when the first switching valve is opened, from which the dehydrated fluid therein is discharged outside when the first switching valve is closed, the first switching valve remaining open except for a period during which the stored dehydrated fluid needs to be discharged, and that is provided with a vacuum-equalizing pipe connected to the upper chamber via a second switching valve, vacuum pressures of the upper chamber and the lower chamber being equalized when the second switching valve is opened; a fluid transportation pump that is connected to the lower chamber via a second pipe and causes the fluid stored in the lower chamber to be discharged when the first switching valve is closed; a vacuum pump that is connected to the upper chamber via a third pipe and creates a vacuum pressure in the upper chamber; and a control unit which performs opening and closing of the first switching valve and the second switching valve and also controls operation of the fluid transportation pump and the vacuum pump.

Preferably, the upper chamber may include: an upper inclined panel that causes a condensate, generated due to condensation of the evaporated dissolved water, to flow down to one side thereof; and a gutter that collects and discharges the condensate that flows down along the upper inclined panel, wherein the condensate collected in the gutter is introduced into and stored in a water-collecting chamber by a vacuum pressure created by the vacuum pump, and is then discharged outside.

Preferably, the control unit may perform control of: causing a level sensor to sense a level of the fluid stored in the lower chamber; closing the first switching valve and activating the fluid transportation pump when the level of the fluid stored in the lower chamber is high; deactivating the fluid transportation pump and opening the second switching valve for a predetermined period of time so that vacuum pressures of the upper chamber and the lower chamber are equalized when the level of the fluid stored in the lower chamber is low; and subsequently opening the first switching valve so that the dehydrated fluid in the upper chamber is introduced into and stored in the lower chamber.

Preferably, the apparatus may further include an air breather connected to the lower chamber via a vacuum-releasing pipe and a third switching valve, wherein the air breather alleviates the vacuum pressure of the lower chamber, only to a vacuum pressure at which the fluid transportation pump is capable of normally discharging the fluid, when the second switching valve is closed and the third switching valve is opened.

Preferably, the water-containing fluid may be sprayed through a spray nozzle under conditions in which the upper chamber maintains a vacuum pressure of 70 Torr (abs) or lower.

According to another aspect, there is provided a chamber for an apparatus for removing dissolved water from a water-containing fluid, the chamber is structured such that: the water-containing fluid is sprayed into the chamber through a spray nozzle under conditions in which a vacuum pressure is maintained; the dissolved water contained in the water-containing fluid is evaporated in the chamber and then discharged outside through a vapor discharge pipe; and a dehydrated fluid, which is a remnant of the water-containing fluid after the dissolved water is evaporated, is discharged separately from the dissolved water, through a fluid discharge pipe, the chamber including: an upper inclined panel that allows a condensate generated due to condensation of the evaporated dissolved water to flow down to one side thereof; and a gutter that collects the condensate that flows down along the upper inclined panel therein and then discharges the collected condensate through a water discharge pipe.

### Advantageous Effects

According to the disclosure, a water-containing fluid (for example, a hydrophobic fluid such as an industrial oil in which water is dissolved) is sprayed into a chamber (especially an upper chamber) that maintains a high vacuum pressure of 70 Torr (abs) or lower. So, the disclosure has an advantage of effectively separating and removing the dissolved water using a difference in saturation vapor pressure even under conditions in which a to-be-recycled hydrophobic fluid is heated to a moderate temperature at which the hydrophobic fluid does not undergo a chemical change.

According to the disclosure, since pressure conditions of a lower chamber are just slightly changed from a high vacuum pressure (for example, 70 Torr (abs) or lower) which is almost equal to a vacuum pressure of an upper chamber when a fluid is discharged from the lower chamber, there is an advantage of improvement in operation efficiency of equipment, when considering control of a pressure condition.

In addition, according to the disclosure, since both of the upper chamber and the lower chamber are maintained under conditions of high vacuum pressure (for example, 70 Torr (abs) or lower) or conditions of near-high-vacuum pressure, it is unnecessary to heat the water-containing fluid to an excessively high temperature before the water-containing fluid is introduced into the upper chamber. Therefore, the apparatus according to the disclosure is advantageous in that it is possible to easily control heating conditions or operation conditions of equipment and to prevent chemical change attributable to excessive heating of the fluid.

In addition, according to the disclosure, since only the water level of the lower chamber is controlled and there is no need to manage or control the water level of the upper chamber, operation efficiency of equipment is improved and it is possible to fundamentally prevent a state where the fluid unexpectedly reaches a high level in the upper chamber.

In addition, according to the disclosure, since the upper chamber is constructed to discharge water that is a condensate generated in the upper chamber using a simple water-collecting structure rather than evaporate the water using an additional heater, there are the advantages of it being possible to eliminate inconvenience which may be caused by installing and managing an additional heat source, as well as to fundamentally prevent occurrence of a chemical change of the fluid attributable to over-heating.

### DESCRIPTION OF DRAWINGS

FIG. 1 is a system configuration diagram illustrating an apparatus for removing dissolved water from a water-containing fluid according to one embodiment of the disclosure;

FIG. 2 is a flowchart illustrating operation of the apparatus for removing dissolved water from a water-containing fluid according the embodiment of the disclosure; and

FIG. 3 is a flowchart illustrating operation of the apparatus, which follows the steps illustrated in FIG. 2.

### BEST MODE FOR INVENTION

The disclosure can be embodied in various forms without departing from key features and sprit of the disclosure. Accordingly, embodiments of the disclosure are only illustrative purposes and are not construed to be limitative.

It will be understood that, although the terms “first,” “second,” etc. may be used herein to describe various elements, these elements should not be limited by these terms.

These terms are only used to distinguish one element from another element. For instance, a first element discussed below could be termed a second element without departing from the teachings of the disclosure. Similarly, the second element could also be termed the first element.

The term “and/or” includes any and all combinations of one or more of the associated listed items.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this disclosure belongs.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, in order to help describe the disclosure in so detail that those skilled in the art to which the disclosure belongs can easily practice the disclosure, preferred embodiments of the disclosure will be described in detail with reference to the accompanying drawings.

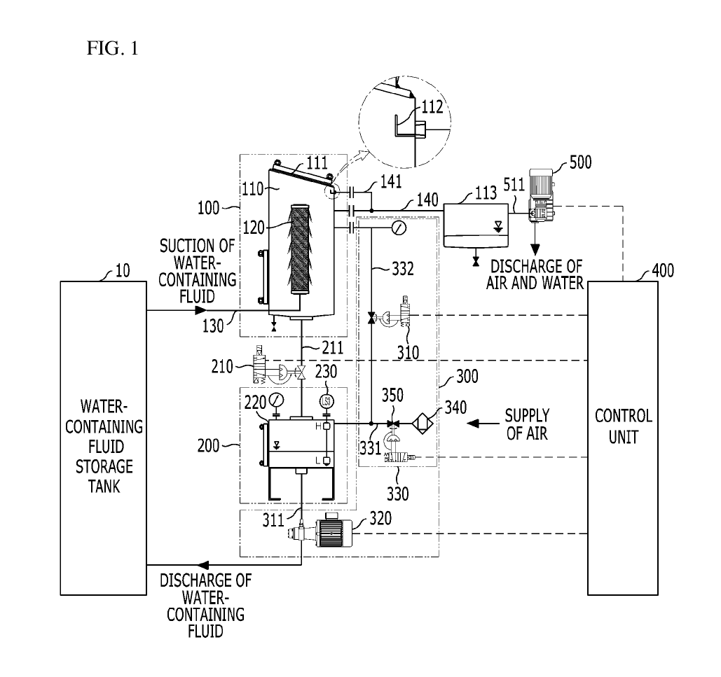

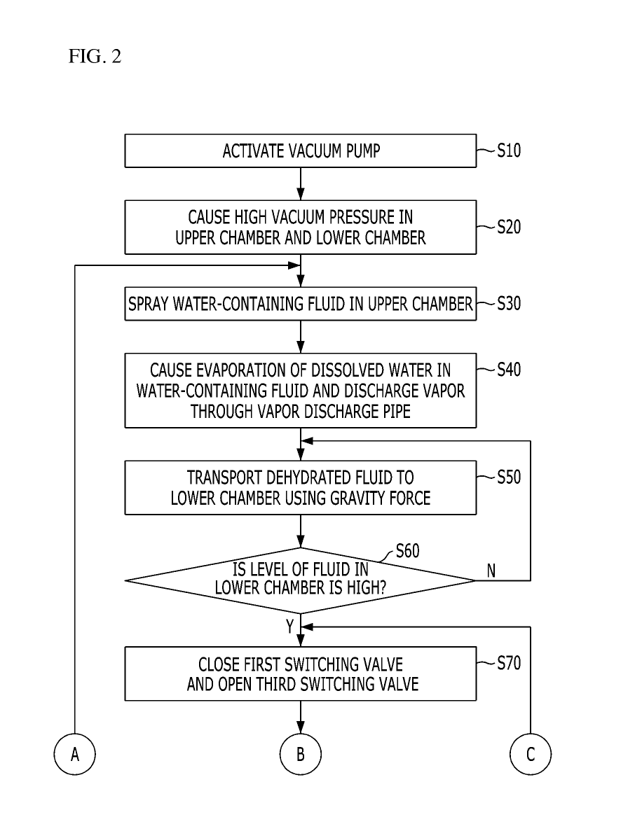

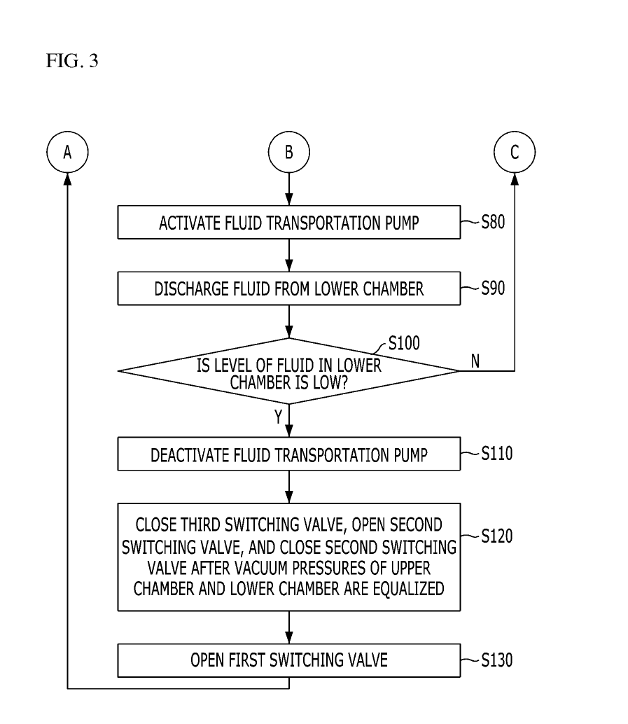

FIG. 1 is a system configuration diagram illustrating an apparatus for removing dissolved water from a water-containing fluid according to one embodiment of the disclosure; FIG. 2 is a flowchart illustrating operation of the apparatus for removing dissolved water from a water-containing fluid according the embodiment of the disclosure; and FIG. 3 is a flowchart illustrating operation of the apparatus, which follows the steps illustrated in FIG. 2.

As illustrated in FIG. 1, the apparatus for removing dissolved water from a water-containing material according to one embodiment of the disclosure includes an upper chamber assembly 100, a lower chamber assembly 200, a fluid discharge unit 300, a control unit 400, and a vacuum pump 500.

The upper chamber assembly 100 includes an upper chamber 110 that maintains conditions of high vacuum pressure (for example, 70 Torr (abs) or lower), and a spray nozzle 120 that is installed in the upper chamber 110 and through which the water-containing fluid is sprayed into the upper chamber 110.

The spray nozzle 120 includes a plurality of fine holes, and the surface area of the water-containing fluid is increased while the water-containing fluid is passing through the spray nozzle 120. This improves evaporation efficiency of dissolved water. The spray nozzle 120 may be any one of the structures known for spray nozzles and may not be limited to any particular structure. Therefore, a description about the structure of the spray nozzle is omitted.

The water-containing fluid is pre-heated to an adequate temperature by a heating means (not illustrated) before being sprayed into the upper chamber 110. The term “adequate temperature” may be construed as a saturated vapor temperature at which dissolved water evaporates under high vacuum pressure conditions in the upper chamber 110.

For example, when the vacuum pressure conditions of the upper chamber 110 are maintained at 70 Torr (abs), the dissolved water evaporates at 44.40° C. Accordingly, when the vacuum pressure conditions of the upper chamber 110 are maintained to be below 70 Torr (abs) and when the water-containing fluid is heated to 44.40° C. or lower by a heating means (not illustrated) before being sprayed into the upper chamber 110, the water-containing fluid is likely to evaporate.

For example, the temperature constraint of 44.40° C. or lower is a relatively low temperature compared to a heating temperature of 80° C. at which the waste lubricant undergoes an abrupt chemical change. The apparatus for removing dissolved water from a water-containing fluid according to the present embodiment effectively removes dissolved water contained in the water-containing fluid even at a temperature that is far below the chemical transition temperature at which a hydrophobic fluid undergoes a chemical change by maintaining the high vacuum pressure (for example, 70 Torr (abs) or lower) of the upper chamber 110.

The water-containing fluid is suctioned and sprayed into the upper chamber 110 through the spray nozzle 120 due to action of the high vacuum pressure in the upper chamber 110. At this point, the saturated vapor temperature of the dissolved water contained in the water-containing fluid sprayed into the upper chamber is lowered to the saturated vapor temperature corresponding to the high vacuum pressure of the inside of the upper chamber 110. For this reason, the dissolved water in the water-containing fluid evaporates. Furthermore, as the conditions of the high vacuum pressure and temperature in the upper chamber 110 are not suitable for evaporation of a fluid (for example, oil) of the water-containing fluid, only the dissolved water in the water-containing fluid is vaporized to be removed.

Based on this principle, the dissolved water which evaporates in the upper chamber 110 is discharged to a vapor discharge pipe 140 connected to the upper chamber 110.

On the other hand, a portion of the dissolved water which evaporates in the upper chamber 110 cannot be discharged to the vapor discharge pipe 140 due to condensation attributable to a temperature difference between the inside and outside of the upper chamber 110 but condenses on the wall, especially the upper surface of the upper chamber 110. The condensate on the upper surface of the upper chamber 110 drops to be mixed again with the dehydrated fluid from which the dissolved water is removed, resulting in a decrease in removal efficiency of dissolved water.

In order to solve this problem, according to the present embodiment, the upper chamber has an upper inclined panel 111 that is inclined at a predetermined angle. In addition, a gutter 112 is installed under a lower end of the upper inclined panel 111 in order to collect water drops (condensate) flowing down along the upper inclined panel 111, and then the collected water drops are discharged outside. In this way, it is possible to prevent the condensate on the upper inclined panel of the upper chamber 110 from dropping inside the upper chamber 110, thereby increasing the water removal efficiency. The shape or number of the upper inclined panels 111, or the shape or number of the gutters 112 are not particularly limited as long as the condensate can be easily collected as water and discharged outside.

The water collected in the gutter 112 is discharged through a water discharge pipe 141 that is connected between the gutter 112 and the vapor discharge pipe 140, then stored in a water-collecting chamber 113, and finally removed.

The lower chamber assembly 200 includes a lower chamber 220 that is connected to the upper chamber 110 via a first pipe 211 associated with a first switching valve 210 and that stores a dehydrated fluid, a remnant of the water-containing fluid from which the dissolved water is removed, which is discharged from the upper chamber 110. The lower chamber assembly further includes a level sensor 230 that senses the level of the dehydrated fluid stored in the lower chamber 220.

According to the present embodiment, the first switching valve 210 normally remains open during operation of the apparatus except for a period in which the dehydrated fluid stored in the lower chamber 220 is discharged. The dehydrated fluid that underwent dehydration in the upper chamber is transported to the lower chamber 220 via the first discharge pipe 211 and then stored in the lower chamber 220. When the dehydrated fluid that is transported to the lower chamber 220 reaches a high level (predetermined level): the level sensor 230 senses the high level of the dehydrated fluid; and the control unit 400 performs control of closing the first switching valve 210 and activating the fluid discharge unit 300 so that the dehydrated fluid stored in the lower chamber 220 can be discharged. Even while the dehydrated fluid is being discharged outside the lower chamber 220, the high vacuum pressure conditions (for example, 70 Torr (abs) or lower) of the upper chamber 110 are maintained so that the dissolved water can continuously evaporate in the upper chamber 110.

The fluid discharge unit 300 includes: a fluid transportation pump 320 connected to the lower chamber 220 via a second pipe 311; and a vacuum-degree adjustment unit 330 that slightly reduces the vacuum degree of the lower chamber 220 when the dehydrated fluid is discharged from the lower chamber 220 and returns the vacuum degrees of the upper chamber 110 and the lower chamber 220 to a predetermined vacuum degree after the dehydrated fluid is discharged.

The control unit 400 performs overall operation of the apparatus, including opening and closing the first switching valve 210 and the second switching valve 310 and activation/deactivation of the fluid transportation pump 320 and the vacuum pump 500.

When the fluid level in the lower chamber 220 is lowered to a low level, the control unit 400 deactivates the fluid discharge unit 300, then opens the second switching valve 310 installed on a vacuum-equalizing pipe 332 for a predetermined period of time so that the vacuum pressures of the upper chamber 110 and the lower chamber 220 can be equalized, and finally opens the first switching valve 110 so that the dehydrated fluid produced in the upper chamber 110 can be transported to the lower chamber 220.

The predetermined period of time during which the second switching valve 310 is opened may be preset by entering an estimated time that is estimated to take to reach equilibrium in vacuum pressure into the control unit 400. Alternatively, pressure gauges (not illustrated) are installed for the upper chamber 110 and the lower chamber 220, respectively; the control unit 400 confirms if the vacuum pressures of the upper chamber and the lower chamber reach equilibrium from the pressure gauges and then performs control of opening/closing the switching valves based on the result of the confirmation. Although it is preferable that the vacuum pressures of the upper chamber 110 and the lower chamber 220 reach a perfect equilibrium, the control unit may perform the control, assuming that the vacuum pressures has reached an equilibrium when the vacuum pressures are substantially equal to each other.

The vacuum-degree adjustment unit 330 includes an air breather 340, a third switching valve 350 that is installed on a vacuum-releasing pipe 331 connected between the air breather 340 and the lower chamber 220, and a second switching valve 310 that is installed on the vacuum-equalizing pipe 332 connected between the fore part of the second switching valve 310 and the upper chamber 110 and that blocks and unblocks the vacuum-equalizing pipe 332.

The control unit 400 opens the third switching valve 350 when discharging the dehydrated fluid from the lower chamber 220 so that a trace of air can be supplied to the lower chamber 220 through the air breather 340. In this way, the control unit alleviates the vacuum degree of the lower chamber 220 to the extent that the fluid transportation pump 320 can discharge and transport the dehydrated fluid, i.e. to a low vacuum pressure which is slightly higher than 70 Torr (abs), and activates the fluid transportation pump 320 in order to discharge the dehydrated fluid from the lower chamber 220. The alleviation of the vacuum degree and activation of the fluid transportation pump are simultaneously performed.

As described above, as the vacuum pressure of the lower chamber 220 is alleviated by using the air breather 340 unlike the known technology that uses the ventilation pipe, there is an advantage that the pressure of the lower chamber 220 can be precisely controlled. Furthermore, the apparatus according to the present embodiment has another advantage that it is possible to perform control of just slightly alleviating the vacuum pressure of the lower chamber 220 to the extent that the fluid transportation pump 320 can transport the fluid rather than changing the vacuum pressure to a near-atmospheric pressure. For this reason, operation efficiency of the apparatus is improved.

Meanwhile, when the dehydrated fluid is discharged outside the lower chamber 220 and the level sensor 230 of the lower chamber 220 senses the low level, the control unit 400 closes the third switching valve 350 and deactivates the fluid transportation pump 320 simultaneously, and also opens the second switching valve 310 for a predetermined period of time so that the vacuum pressures of the upper chamber 110 and the lower chamber 220 can reach an equilibrium. After that, the control unit 400 closes the second switching valve 310 and opens the first switching valve 210 so that the dehydrated fluid can be transported to the lower chamber 220 from the upper chamber 110 by the gravity force.

The vacuum pump 500 for creating a vacuum pressure is connected to the upper chamber 110 via a third pipe 511, thereby causing the inside of the upper chamber 110 and the lower chamber 220 to be in a vacuum pressure state.

The operation flow of the apparatus for removing dissolved water from a water-containing fluid according to the preferred embodiment of the disclosure will be described with reference to FIGS. 1, 2, and 3.

First, the first switching valve 210 is opened, the second switching valve 310 and the third switching valve 350 are closed, and the vacuum pump 500 is activated (Step S10). Then, the internal pressures of the water-collecting chamber 113, the lower chamber 220, and the upper chamber 110 connected to the vacuum pump 500 via a pipe are lowered to the high vacuum pressure (70 Torr (abs) or lower) (Step S20).

The water-containing fluid stored in a storage tank 10 that contains the water-containing fluid therein is suctioned toward the upper chamber 110 through a fourth pipe 130 due to the high vacuum pressure (70 Torr (abs) or lower) and is sprayed into the upper chamber 110 through the spray nozzle 120 installed at an end of the fourth pipe 130 (Step S30). Here, the fourth pipe 130 may extend to a position which is lower in height than the water level of the water-containing fluid in the storage tank 10 so that the water-containing fluid can be suctioned.

When the water-containing fluid is sprayed into the upper chamber 110 through the spray nozzle 120, the saturated vapor temperature of water is decreased due to the high vacuum pressure (70 Torr (abs) or lower) in the upper chamber 110. Accordingly, dissolved water in the water-containing fluid evaporates, and the resultant vapor is discharged through a vapor discharge pipe 140 by the vacuum pressure created by the vacuum pump 500 (Step S40).

On the other hand, while the dissolved water is evaporating in the upper chamber 110, a portion of the resultant vapor condenses on the inside surface of the upper inclined panel 111 of the upper chamber 110 so that a portion of the vapor changed to the condensate cannot be discharged outside through the vapor discharge pipe 140. According to the present embodiment, the condensate on the inside surface of the upper inclined panel of the upper chamber 110 can be collected and then discharged outside.

That is, as described above, since the upper chamber 110 of the water removal system according to the present embodiment has the upper inclined panel 111 that is inclined at a predetermined angle, the condensate formed on the ceiling of the upper chamber is guided to flow down along the surface of the upper inclined panel 111 and collected in the water-collecting rib 112 disposed under the lower end of the inclined upper panel 111. Therefore, the condensate will not be mixed again with the fluid retained in the upper chamber 110.

The water collected in the gutter 112 is transported through the water discharge pipe 141 along with vapor which is discharged through the vapor discharge pipe 140. Then, the water is collected in the water-collecting chamber 113 and then treated.

The dehydrated fluid from which the dissolved water is vaporized in the upper chamber 110 is transported to and then stored in the lower chamber 220 (Step S50).

When the level of the fluid in the lower chamber 220 is detected to be a high level by the level sensor 230 (Step S60), the control unit 400 closes the first switching valve 210 provided between the upper chamber 110 and the lower chamber 220 so that transportation of the fluid is blocked, and simultaneously opens the third switching valve 350 so that a trace of air can be supplied to the lower chamber 220. In this way, the vacuum degree of the lower chamber 220 is alleviated to an adequate vacuum degree (Step S70).

Subsequently, the control unit 400 activates the fluid transportation pump 320 (Step S80) to discharge the fluid stored in the lower chamber 220 (Step S90). The dehydrated fluid, from which the dissolved water is removed, is transported to and then stored in a fluid storage tank (not illustrated).

When the level of the fluid in the lower chamber 220 is detected to be a low level by the level sensor 230 while the fluid is being discharged from the lower chamber 220 (Step S100), the control unit 400 deactivates the fluid transportation pump 320 (Step S110), then closes the third switching valve 350 and opens the second switching valve 310 for a predetermined period of time so that the internal vacuum pressures of the upper chamber 110 and the lower chamber 220 reach an equilibrium, and finally closes the second switching valve 310 (Step S120).

Subsequently, the first switching valve 210 is opened so that the fluid, from which the dissolved water is removed and which is stored in the upper chamber 110 for a period of time during which the first switching valve 210 is closed, can be transported to the lower chamber 220 by the gravity force (Step S130).

As described above, even while the fluid is being discharged from the lower chamber 220, a change in the vacuum degree of the upper chamber 110 is not so large but the inside of the upper chamber 110 remains high in vacuum pressure (for example, about 70 Torr (abs) or lower). Therefore, evaporation of the dissolved water continues in the upper chamber 110, the dehydrated fluid, from which the dissolved water is removed, is temporarily stored in the upper chamber 110 and then transported to the lower chamber 220 by the gravity force when the first switching valve 210 is opened.

As described above, in the technology which removes dissolved water from a water-containing fluid according to the present embodiment, Step S10 to Step S130 are sequential processes automatically performed under high vacuum pressures (70 Torr (abs) or lower). Accordingly, it is possible to precisely, effectively, and rapidly remove the dissolved water.

In addition, in the technology which removes dissolved water from a water-containing fluid according to the present embodiment, condensate drops generated in the upper chamber 110 are collected in the gutter 112, then transported to the water-collecting chamber 113 through the water discharge pipe 141, and finally discharged outside the apparatus. Accordingly, it is possible to more precisely remove the dissolved water and improve removal efficiency of the dissolved water compared to known technologies. Therefore, as the water removal time is shortened, it is possible to expect the effect of improvement in productivity.

The water stored in the water-collecting chamber 113 can be discharged outside using a known discharging means. The discharging means is disclosed in many related arts, including Korean Patent No. 10-0407161.

The comparison and measurement of water removal efficiency between the apparatus for removing dissolved water from a water-containing fluid according to the preferred embodiment of the disclosure and the apparatus disclosed in the related art (Korean Patent No. 10-0407161) is shown in Table 1. As the apparatus for removing dissolved water from a water-containing fluid according to the preferred embodiment of the disclosure, the structure that is provided with the gutter and the water-collecting chamber to remove water drops that are generated due to condensation is used for the comparison and measurement.

TABLE 1

| | Related Art | | Embodiment | |
|---|---|---|---|---|
| | Before | After | Before | After |
| | treatment | treatment | treatment | treatment |
| Classification | (ppm) | (ppm) | (ppm) | (ppm) |
| Degree of | 3000 | 266 | 3350 | 78 |
| Water Removal | | | | |

As seen from Table 1, the remaining water content in a sample which is treated by the apparatus for removing dissolved water from a water-containing fluid according to the preferred embodiment of the disclosure is about one-third of the remaining water content in a sample which is treated by the related art. That is, it is seen that the apparatus according to the embodiment of the disclosure has far higher water removal efficiency.

Although a preferred embodiment of the disclosure has been described for illustrative purposes, which are provided for only an illustrative purpose, but it is to be understood that various alternatives, modifications, and equivalents are possible. Accordingly, disclosed embodiments should be construed to be illustrative and not limitative in all aspects, and all obvious modifications for those skilled in the art may fall within the scope of the disclosure.

1. An apparatus for removing dissolved water from a water-containing fluid, comprising:
an upper chamber into which the water-containing fluid is sprayed through a spray nozzle under a vacuum pressure condition, in which the dissolved water contained in the water-containing fluid is evaporated, and from which the evaporated water and a dehydrated fluid, which is a remnant of the water-containing fluid after the dissolved water is evaporated, are discharged separately;
a lower chamber, which is connected to the upper chamber via a first pipe and a first switching valve, into and in which the dehydrated fluid is introduced and stored when the first switching valve is opened, from which the dehydrated fluid therein is discharged outside when the first switching valve is closed, the first switching valve remaining open except for a period during which the stored dehydrated fluid needs to be discharged, and that is provided with a vacuum-equalizing pipe connected to the upper chamber via a second switching valve, vacuum pressures of the upper chamber and the lower chamber being equalized when the second switching valve is opened;
a fluid transportation pump that is connected to the lower chamber via a second pipe and causes the fluid stored in the lower chamber to be discharged when the first switching valve is closed;
a vacuum pump that is connected to the upper chamber via a third pipe and creates a vacuum pressure in the upper chamber; and
a control unit which performs opening and closing of the first switching valve and the second switching valve and also controls operation of the fluid transportation pump and the vacuum pump.

2. The apparatus for removing dissolved water from a water-containing fluid according to claim 1, wherein the upper chamber includes:
an upper inclined panel that causes a condensate, generated due to condensation of the evaporated dissolved water, to flow down to one side thereof; and
a gutter that collects and discharges the condensate that flows down along the upper inclined panel,
wherein the condensate collected in the gutter is introduced into and stored in a water-collecting chamber by a vacuum pressure created by the vacuum pump, and is then discharged outside.

3. The apparatus for removing dissolved water from a water-containing fluid according to claim 1, wherein the control unit performs control of:
causing a level sensor to sense a level of the fluid stored in the lower chamber;
closing the first switching valve and activating the fluid transportation pump when the level of the fluid stored in the lower chamber is high;
deactivating the fluid transportation pump and opening the second switching valve for a predetermined period of time so that vacuum pressures of the upper chamber and the lower chamber are equalized when the level of the fluid stored in the lower chamber is low; and
subsequently opening the first switching valve so that the dehydrated fluid in the upper chamber is introduced into and stored in the lower chamber.

4. The apparatus for removing dissolved water from a water-containing fluid according to claim 1, further comprising:
an air breather connected to the lower chamber via a vacuum-releasing pipe and a third switching valve,
wherein the air breather alleviates the vacuum pressure of the lower chamber, only to a vacuum pressure at which the fluid transportation pump is capable of normally discharging the fluid, when the second switching valve is closed and the third switching valve is opened.

5. The apparatus for removing dissolved water from a water-containing fluid according to claim 1, wherein the water-containing fluid is sprayed through a spray nozzle under conditions in which the upper chamber maintains a vacuum pressure of 70 Torr (abs) or lower.

6. A chamber for an apparatus for removing dissolved water from a water-containing fluid, the chamber structured such that:
the water-containing fluid is sprayed into the chamber through a spray nozzle under conditions in which a vacuum pressure is maintained;
the dissolved water contained in the water-containing fluid is evaporated in the chamber and then discharged outside through a vapor discharge pipe; and
a dehydrated fluid, which is a remnant of the water-containing fluid after the dissolved water is evaporated, is discharged separately from the dissolved water, through a fluid discharge pipe,
the chamber including: an upper inclined panel that allows a condensate generated due to condensation of the evaporated dissolved water to flow down to one side thereof; and a gutter that collects the condensate that flows down along the upper inclined panel therein and then discharges the collected condensate through a water discharge pipe.
